(19) United States
(12) Patent Application Publication
(10) Pub. No.: US 2009/0103737 A1
(43) Pub. Date: Apr. 23, 2009

(54) 3D SOUND REPRODUCTION APPARATUS USING VIRTUAL SPEAKER TECHNIQUE IN PLURAL CHANNEL SPEAKER ENVIRONMENT

(76) Inventors: Poong Min KIM, Daejeon-si (KR); Hyoun Suk KIM, Daejeon-si (KR); In Ho LEE, Daejeon-si (KR); Jong Woo KIM, Daejeon-si (KR); Myung Cheol LEE, Daejeon-si (KR)

Correspondence Address: BIRCH STEWART KOLASCH & BIRCH, PO BOX 747, FALLS CHURCH, VA, 22040-0747, US

(21) Appl. No.: 12/110,002

(22) Filed: Apr. 25, 2008

(30) Foreign Application Priority Data
Oct. 22, 2007 (KR) 10-2007-106118
Mar. 20, 2008 (KR) 10-2008-25757

(51) Int. Cl. H04R 5/00

(52) U.S. Cl. 381/17

(57) ABSTRACT

Disclosed herein is an apparatus for providing 3D sound through plural-channel speakers. The apparatus includes a stereo channel virtual speaker generation device for performing spreading of low-pitch ranges and high-pitch ranges on input left and right channel signals, performing spreading of sound images and preservation of front sound images using the high-pitch range-spread signals, and outputting the sums of left and right processing results; a multi channel virtual speaker generation device for performing spreading of low-pitch ranges and high-pitch ranges on input left front channel, right front channel, left surround channel and right surround channel signals, performing spreading of sound images using the high-pitch range-spread signals, performing preservation of front sound images using front center channel and LFE channel signals, adjusting the gains of the processing results, and outputting the sums of left and right processing results, and an output device for outputting the signals to the plural-channel speakers.

### BACKGROUND OF THE INVENTION

1. Field of the Invention

The present invention relates to an apparatus for reproducing three-dimensional (3D) sound using virtual speaker at the time of outputting a source sound signal through plural channel speakers.

2. Description of the Related Art

The basic principle of the perception of three-dimensional (3D) sound is to extract information, sufficient to determine the location of a sound source in 3D space, from the distance and temporal difference between signals input to two human ears, determine the location of the sound source, and sense a 3D impression.

Meanwhile, when sound is reproduced using stereo speakers, a sound image is located in the space between two stereo speakers, and thus the impression of presence sensed by two human ears is reduced. Accordingly, 3D sound having presence can be produced only by making a listener sense that a sound image seems to be located out of the regions of two speakers by spreading the components region of stereo sound signals. Meanwhile, a stereo enhancement technique for producing a 3D impression in such a way as to enable a listener to sense that a sound image is located out of speaker regions by enhancing the components of stereo sound is being used as the basic technique of 3D sound technology.

Furthermore, when multi-channel (5.1-channel) source sound is received and output through stereo speakers, it is impossible to realize the 3D impression of the sound image. Accordingly, recently, systems for providing a virtual surround effect so that a surround sound effect, which creates the impression in which sound seems to be output from a 5.1-channel system when source sound input in a multi-channel manner is output through stereo speakers, have been developed.

Technology related to a system for reproducing 5.1-channel audio through 2-channel speakers is disclosed in WO 99/49574 (PCT/AU99/00002 filed on Jan. 6, 1999, and entitled “AUDIO SIGNAL PROCESSING METHOD AND APPARATUS”), and technology related to a 3D sound reproduction system is disclosed in WO 99/49574 (PCT/AU99/00002 filed on Jan. 6, 1999, and entitled “AUDIO SIGNAL PROCESSING METHOD AND APPARATUS”).

Meanwhile, in the prior art 3D sound reproduction technologies, input signals and impulse responses are convoluted together, source sound is positioned at a desired location using a Head Related Transfer Function (HRTF), a listener is enabled to have an impression of presence by separating stereo audio into right and left components using a crosstalk cancellation filter, and the range of sound is spread by enhancing a weak low-pitch range at the time of reproducing 3D sound. Methods of spreading low-pitch ranges, which are applied to the prior art technologies, include a technology for separating low-pitch range portions using a Low Pass Filter (LPF) and applying the sum of and difference between signals to output low-pitch range signals, a method of performing enhancement using harmonics, and a method using sine and cosine functions.

However, the prior art technologies have problems in that the distortion of the source sound may occur in the process of spreading a sound range and the impression of spreading is decreased, and it is difficult to form a sound image at a rear location when a multi-channel reproduction technology has a high correlation between right and left surround channels. Furthermore, the HRTF enables right and left sound images to be easily distinguished from one another on the horizontal plane and makes the distinction between front and back sound images difficult due to errors with the standard HRTF. In order to distinguish front and back locations from each other, the end user must accurately measure frequency characteristics. However, in the case in which a standard dummy head is used, there is a difference in frequency characteristics related to an end user, and thus front/back confusion occurs.

Furthermore, in the prior art, in the case of surround channels, the effect of the surround channels can be achieved only when sound images are located on the right side, left side, right back side and left back side of a listener. In the case in which there is a high correlation between the audio input signals of right and left surround channels, the effect in which a sound image is located at a back center occurs. Furthermore, when the ranges of right and left sound images are spread, a problem occurs in that a front sound image is weakened, thereby weakening a 3D impression at the time of reproducing 3D sound.

### SUMMARY OF THE INVENTION

Accordingly, the present invention has been made keeping in mind the above problems occurring in the prior art, and an object of the present invention is to provide virtual speakers that are constructed by adding preprocessing for preventing the distortion of source sound and adapting the enhancement of low-pitch and high-pitch range signals, thereby spreading sound images over a wider range.

Furthermore, the present invention provides a 3D sound reproduction apparatus using virtual speakers in which the sound images of right and left surround channels are located behind a listener without being influenced by the correlation, and thus virtual surround channels are realized in the output of a stereo output apparatus, thereby providing a listener with a deep impression of presence.

Moreover, the present invention enables various-channel input signals to be reproduced as 3D sound using a stereo output apparatus.

Accordingly, using the present invention, it is possible to provide a 3D sound reproduction apparatus in video systems receiving various signals and portable multimedia devices having 2-channel output devices.

Moreover, the above-described present invention may be applied to 5.1-channel, 3-channel, 2.1-channel, 4-channel or other channel systems, as well as a 2-channel output device (speaker) system (hereinafter 2 or more-channel speakers are abridged as “plural channel speakers”).

In order to accomplish the above objects, the present invention provides an apparatus for providing 3D sound through plural-channel speakers, including a stereo channel virtual speaker generation device for performing spreading of low-pitch ranges and high-pitch ranges on the left and right channel signals of input stereo source sound signals, performing spreading of sound images and preservation of front sound images using the high-pitch range spread signals, and outputting the sums of the left and right results of the processing; a multi-channel virtual speaker generation device for performing spreading of low-pitch ranges and high-pitch ranges on the left front channel, right front channel, left surround channel and right surround channel signals of input multi-channel source sound signals, performing spreading of sound images using the high-pitch range-spread signals, performing preservation of front sound images using front center channel and LFE channel signals, adjusting the gains of the results of the processing, and outputting the sums of the left and right results of the processing; and an output device for outputting the signals, output from the stereo channel virtual speaker generation device or multi-channel virtual speaker generation device, to the plural channel speakers.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a diagram showing the overall construction of virtual speaker generation devices and an output device according to an embodiment of the present invention;

FIG. 2 is a detailed diagram showing the stereo channel virtual speaker generation device for outputting stereo source sound to the stereo output device as 3D sound, shown in FIG. 1;

FIG. 3 is a detailed diagram showing the multi-channel virtual speaker generation device for outputting multi-channel source sound to the stereo output device as 3D sound, shown in FIG. 1;

FIG. 4 is a diagram showing the construction of a stereo sound image enhancement device for stereo source sound according to another embodiment of the present invention; and

FIG. 5 is a diagram showing the construction of a stereo sound image enhancement device for multi-channel source sound according to another embodiment of the present invention.

### DESCRIPTION OF THE PREFERRED EMBODIMENTS

Reference now should be made to the drawings, in which the same reference numerals are used throughout the different drawings to designate the same or similar components.

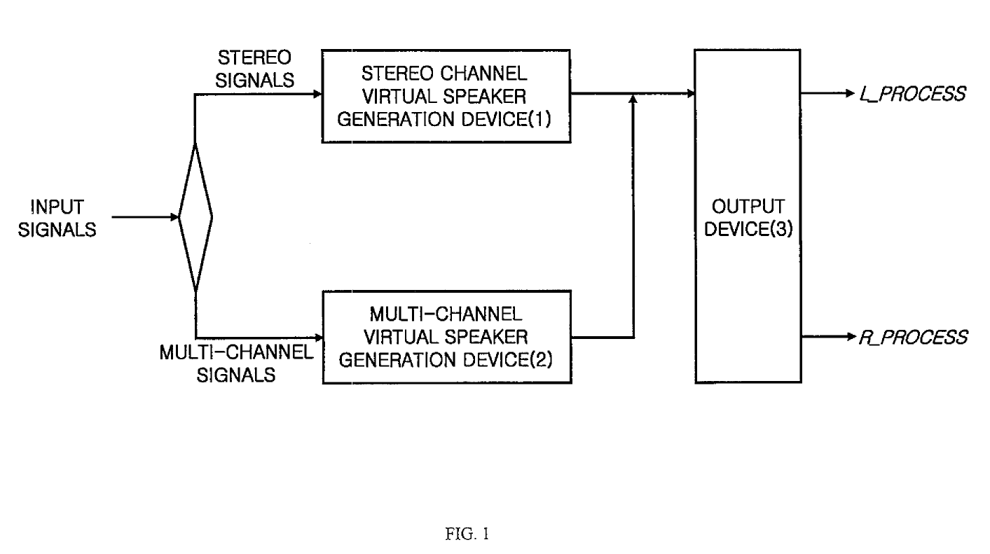

First, virtual speaker generation devices and an output device according to an embodiment of the present invention will be described with reference to FIG. 1. FIG. 1 is a diagram showing the overall construction of the virtual speaker generation devices and the output device.

As shown in FIG. 1, with regard to an input source sound signal, according to the type of signal, stereo signals are input to a stereo channel virtual speaker generation device 1, and 5.1-channel signals are processed for the reproduction of 3D sound in a multi-channel virtual speaker generation device 2. The output of the stereo channel virtual speaker generation device 1 and the output of the multi-channel virtual speaker generation device 2 are reproduced through a 2-channel output device (2-channel speakers) 3.

That is, in a processing method for reproducing 3D sound, with regard to stereo signals, an impression of 3D sound can be created by expanding sound image regions using the stereo channel virtual speaker generation device 1, while, with regard to multi-channel signals, virtual surround speakers located around a listener can be perceived by performing a downmixing process capable of realizing 2-channel output while preserving the channel characteristics of input signals using the multi-channel virtual speaker generation device 2.

Meanwhile, in order to realize a 3D sound effect for stereo source sound, the sound power of the partial ranges of audio signals is increased. In this case, distortion occurs in the partial ranges of the signals, and thus noise may be generated. Furthermore, since it must be assumed that an MP3 signal has been decoded using Pulse Code Modulation (PCM) and the volume of the source sound has been adjusted to the highest level to the extent that distortion thereof is not perceived, a considerable reduction in sound quality occurs in the case in which 3D sound processing is performed on such signals without appropriate preprocessing. Accordingly, a 3D sound effect without the deterioration of sound quality can be achieved only when appropriate correction processing is performed on source sound and 3D processing is then performed.

According to the characteristics of input signals, the input signals are input to the stereo channel virtual speaker generation device 1 or multi-channel virtual speaker generation device 2 of FIG. 1, and thus sound images are spread in the lateral direction.

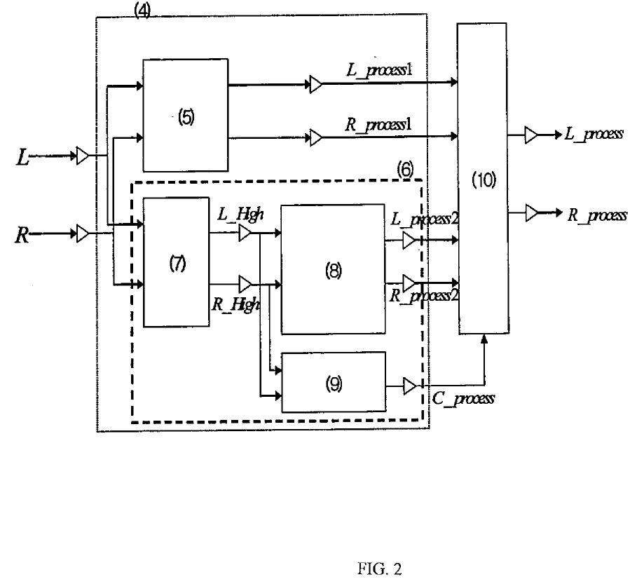

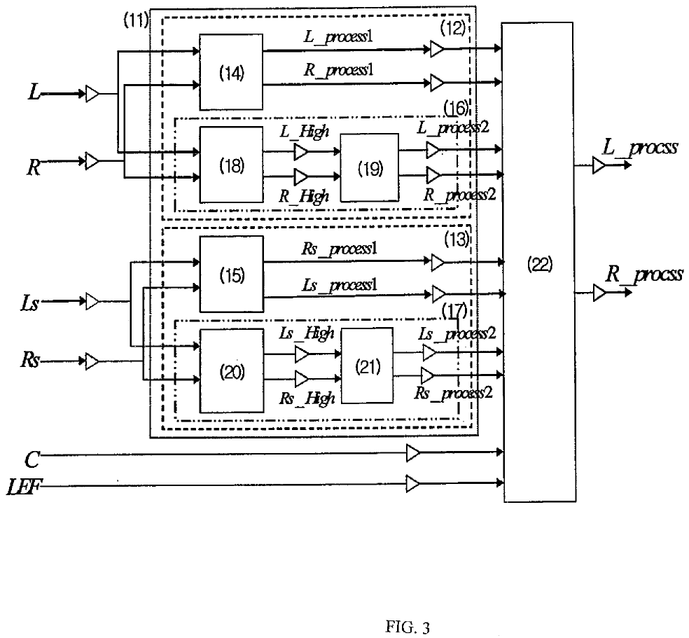

Now, the construction and operation of the stereo channel virtual speaker generation device 1 for generating stereo source sound as 3D sound, and the construction and operation of the multi-channel virtual speaker generation device 2 for outputting multi-channel (5.1-channel) source sound to the stereo output device 3 as 3D sound will be described with reference to FIGS. 2 and 3 in detail.

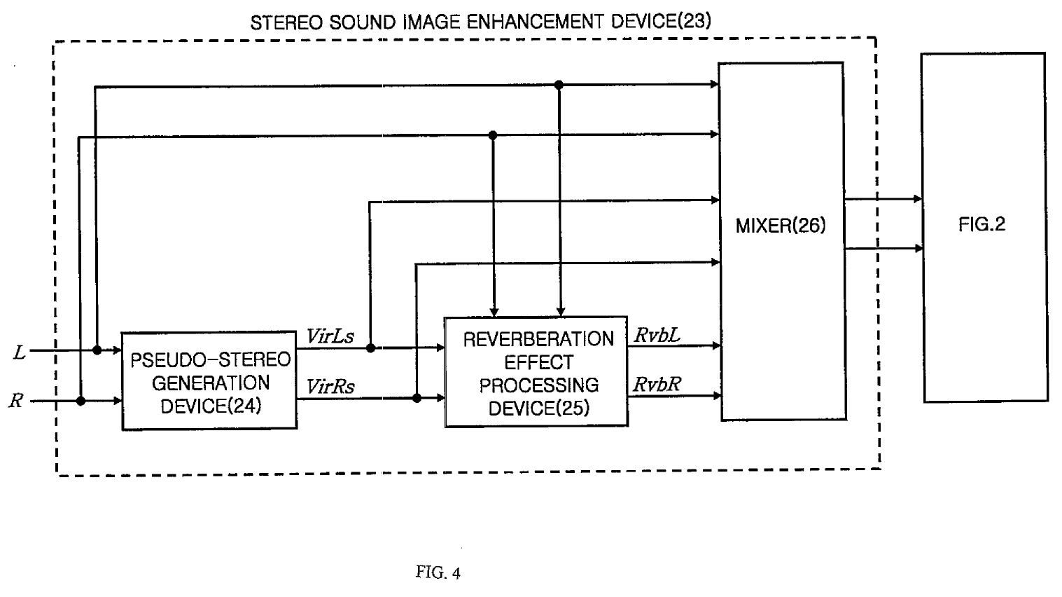

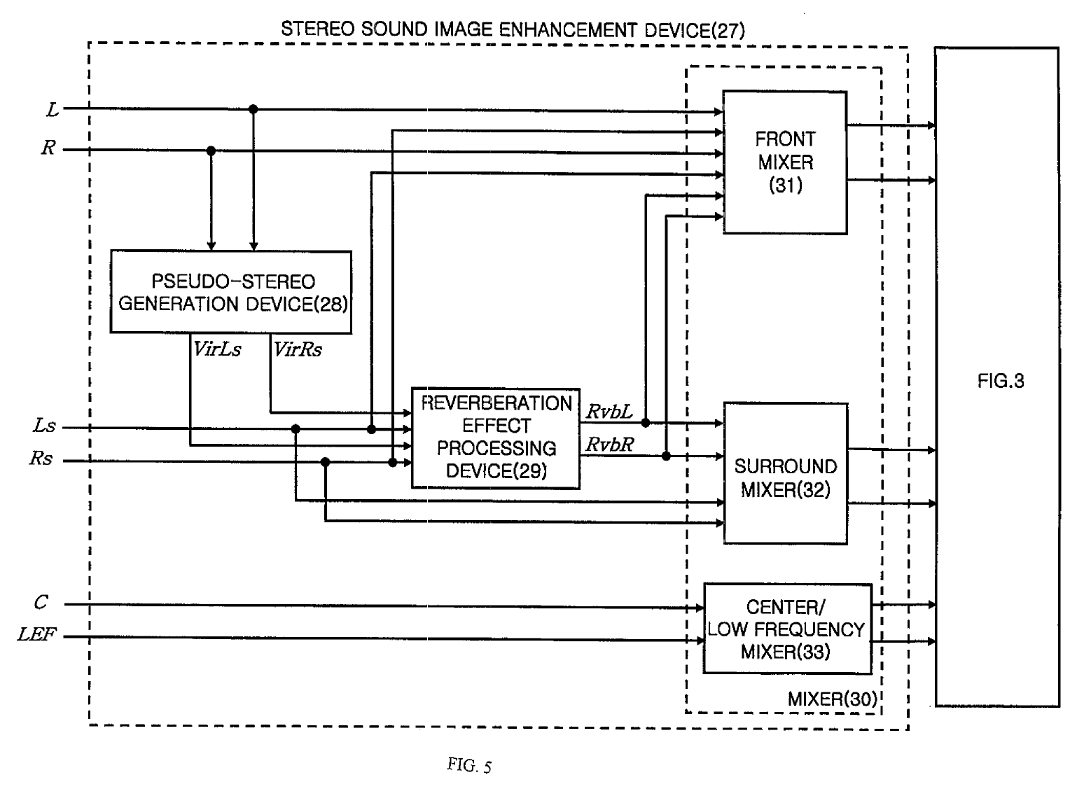

The spreading of sound images in FIGS. 2 and 3 is a process of reducing the correlation between two channels by applying an appropriate audio filter to audio signals in consideration of the characteristics of human auditory perception related to an impression of spreading. FIGS. 4 and 5 show a process of performing an additional function capable of enhancing only stereo sound images without deteriorating the transmitting power of sound, which is an additional process that can be selectively performed before the process of the device of FIG. 2 or 3.

Generally, the impression of spreading of sound images increases as the absolute value of a correlation coefficient between the pieces of data of two right and left channels for stereo becomes close to 0. In this case, the correlation coefficient indicates the degree of existence of common portions between two pieces of data. Two pieces of data in question are identical to each other when the correlation coefficient is 1, two pieces of data in question are two pieces of data that have the same absolute value and different signs when the correlation coefficient is −1, and two pieces of data are different pieces of data when the correlation coefficient is 0.

In the present invention, a method of increasing only different portions between two pieces of data, rather than applying a stereo sound image spreading filter to all input data uniformly, is used as a method of adjusting the degree of preservation of source sound.

As shown in FIG. 2, stereo signals L and R are input to a low-pitch range spreading device 5 and a high-pitch range spreading device 6, multi-channel signals L, R, Ls and Rs are also input to low-pitch range spreading devices 14 and 15 and high-pitch range spreading devices 16 and 17, and then the processing for virtual speaker-based reproduction is performed. In this case, the multi-channel signals L, R. Ls and Rs correspond to a left front channel L, a right front channel R, a left surround channel Ls and a right surround channel Rs, and multi-channel signals further include a front center channel C and a Low-Frequency Effect (LFE) channel LFE.

This will be described in greater detail below.

In order to spread low-pitch range, stereo input signals L and R are input to the low-pitch range spreading device 5, the multi channel input signals L, R, Ls and Rs are input to the low-pitch range spreading devices 14 and 15, and then processing is performed. The input signals L and R are output as L_process1 and R_process1, and surround signals Ls and Rs are output as Ls_process1 and Rs_process1. These may be arranged using the following Equation 1:

L_process1=G_low1*LPF(L)+G_{—}bst*LPF(L)−G_lowI*LPF(R)

R_process1=G_low1*LPF(R)+G_{—}bst*LPF(R)−G_lowI*LPF(L)

Ls_process1=G_low1*LPF(Ls)−G_lowI*LPF(Rs)

Rs_process1=G_low1*LPF(Rs)−G_lowI*LPF(Ls) (1)

where G_low1, G_bst and G_lowI are gains. The enhancement of the low-pitch ranges and the impression of spreading vary with these values, thereby varying the tone of sound and the degree of the impression of spreading that are sensed by a listener.

Next, high-pitch range spreading devices 6, 16 and 17 will be described below.

First, with respect to input signals, stereo signals L and R are input to the device 7, multi-channel signals L, R, Ls and Rs are input to the devices 18 and 20, high-pitch ranges are separated therefrom, and then processing is performed. In the case in which only high-pitch ranges are extracted, the distortion of tone occurs, and thus some of the values of low-pitch regions are used to prevent such distortion. These may be arranged using the following Equation 2:

L_high=G_low2*LPF(L)+G_high*HPF(L)

R_high=G_low2*LPF(R)+G_high*HPF(R)

Ls_high=G_low2*LPF(Ls)+G_high*HPF(Ls)

Rs_high=G_low2*LPF(Rs)+G_high*HPF(Rs) (2)

where L_high, R_high, Ls_high, and Rs_high are signals that are processed and output by the devices 7, 18 and 20.

The output signals processed by the devices 7, 18 and 20 are input to the devices 8, 19 and 21, and a sound image spreading effect is applied to the output signals to be used for virtual speaker output in the manner shown in the following Equation 3:

$$L\_process2 = G\_plus 2 * ( L\_high + R\_high ) + ( G\_minus 2 * ( G\_minus2 * ( L\_high - M 1 ( L\_high ) ) ) - M 1 ( R\_high ) ) \\ R\_process 2 = G\_minus 2 * ( L\_high - R\_high ) + ( G\_plus2 * ( G\_plus 2 * ( R\_high + M 1 ( R\_high ) ) ) + M 1 ( L\_high ) ) \\ Ls\_process2 = G\_plus 2 * ( Ls\_high + Rs\_high ) + ( G\_minus 2 * ( G\_minus2 * ( Ls\_high - M 1 ( Ls\_high ) ) ) - M 1 ( Rs\_high ) ) \\ Rs\_process 2 = G\_minus 2 * ( Ls\_high - Rs\_high ) + ( G\_plus2 * ( G\_plus 2 * ( Rs\_high + M 1 ( Rs\_high ) ) ) + M 1 ( Ls\_high ) ) \qquad ( 3 )$$

where M1 corresponds to a crosstalk cancellation filter, L_process2 and R_process2 are signals that are processed and output with respect to L and R signals, Ls_process2 and Rs_process2 are signals that are processed and output with regard to Ls and Rs signals, and G_plus2 and G_minus2 are gains.

Meanwhile, in the case in which sound ranges are spread using Equation 3 and resulting signals are applied to virtual speaker processing, a phenomenon in which a sound image in front of a listener becomes weak may occur in a process of removing sound images to an area out of speaker areas, and thus a problem in which a center sound image (for example, a human's voice, etc.), which must be located at the center, is perceived as weak occurs from the characteristics of a crosstalk cancellation algorithm.

In the present invention, in order to solve the problem in which the sound image in front of a listener is weakened, with regard to stereo signals, the front image is preserved by processing the data of (L+R) portions having a correlation between two sound ranges, and, with regard to multi-channel input signals, the phenomenon in which the front sound image is weakened is overcome using the values of a C channel and an LFE channel. The device 9 of FIG. 2 is a device for performing processing so as to preserve a front sound image, and performs processing using the following Equation 4:

C_process=G_plus1*(L_high+R_high) (4)

where G_plus1 is a gain that is used to correct the front sound image.

Next, it is essential to sum each of left and right signal components while preserving the characteristics of the signals processed by the sound image spreading device and output resulting signals through a 2-channel output system, and it is necessary to perform postprocessing in which preprocessing is performed in a reverse manner so as to prevent the distortion of the source sound.

For this purpose, in the present invention, according to the type of input signals, the device 10 for summing each of left and right signal components and converting the signals into signals that can be output through virtual speakers is applied to stereo signals, while the device 22 for performing downmixing while preserving the characteristics of each channel and processing signals into output for virtual surround speakers at the time of performing output through stereo speakers is applied to multi-channel signals.

A device 10 for processing stereo signals performs processing using the following Equation 5:

L_process=L_process1+L_process2+C_process

R_process=R_process1+R_process2+C_process (5)

A device 22 for processing multi-channel signals performs processing using the following Equation 6:

$$L\_process = G\_level 1 * L\_process 1 + G\_level 1 * L\_process 2 + G\_level 2 * Ls\_process1 + G\_level 2 * Ls\_process 2 + G\_level 3 * ( C + LEF ) \\ R\_process = G\_level 1 * R\_process 1 + G\_level 1 * R\_process 2 + G\_level 2 * Rs\_process1 + G\_level 2 * Rs\_process 2 + G\_level 3 * ( C + LEF ) \qquad ( 6 )$$

where G_level1, G_level2, and G_level3 are gains that are used for the adjustment of output level and downmixing.

Meanwhile, when only the virtual speaker generation devices 1 and 2 and the output device 3, illustrated in FIG. 1, are used, it is difficult to achieve a reverberation effect that causes a listener to have the impression of being surrounded by sound.

Accordingly, in another embodiment of the present invention, in order to achieve such a reverberation effect, a stereo sound image enhancement device for enhancing stereo sound images, such as those of FIGS. 4 and 5, is additionally installed in front of the virtual speaker generation devices 1 and 2 and the output device 3, illustrated in FIG. 1.

Now, such stereo sound image enhancement devices will be described in detail with reference to FIGS. 4 and 5.

As shown in FIGS. 4 and 5, the stereo sound image enhancement devices 23 and 27 are used as the preprocessing devices of the devices of FIGS. 2 and 3, and are devices that cause listeners to have the impression of being surrounded by sound by extracting pseudo-stereo components from input signals and adding a reverberation effect.

Pseudo-stereo creation devices 24 and 28 are devices for performing creation using input signals L and R. The pseudo-stereo creation device 24 for stereo signals and the pseudo-stereo creation device 28 for multi-channel signals are expressed by the following Equation 7:

VirLs=G_{LmR}*(L−R)+G_{LpR}*(L+R)

VirRs=G_{LpR}*(L+R)+G_{LmR}*(L−R) (7)

In Equation 7, VirLs and VirRs are pseudo-stereo signals L and R that are created by the pseudo-stereo creation devices 24 and 28, and G_{LmR} and G_{LpR} are gains that are used for the adjustment of the intensity of stereo components and the adjustment of the degree of extraction.

Stereo signals VirLs and VirRs created by the pseudo-stereo devices 24 and 28 are input to reverberation effect processing devices 25 and 29 to apply a reverberation effect to the stereo signals. The reverberation effect processing device 25 for stereo signals is expressed by the following Equation 8, and the reverberation effect processing device 29 for multi-channel signals is expressed by the following Equation 9:

RvbL=G_{Rbv}*((G_{virToRvb}VirLs)+(G_{FreToRvb}*L))

RvbR=G_{Rvb}*((G_{VirToRvb}VirRs)+(G_{FreToRvb}*R)) (8)

RvbL=G_{Rvb}*((G_{VirToRvb}VirLs)+(G_{FreToRvb}*Ls))

RvbR=G_{Rvb}((G_{VirToRvb}VirRs)+(G_{FreToRvb}*Rs)) (9)

In Equation 8, RvbL and RvbR are signals created by the reverberation effect processing devices 25 and 29, and to Ls and Rs are surround signals L and R that are input in a multi-channel manner. A natural sound field effect can be achieved by adjusting gains G_{Rvb}, G_{VirToRvb} and G_{FreToRvb}.

G_{Rvb}: gain of the reverberation processing device

G_{VirToRvb}: gain that is used for the application of signals, created by the pseudo-stereo creation devices 24 and 28, to the reverberation effect processing devices 25 and 29

G_{FreToRvb}: gain that is used for the application of an input signal L or R to the reverberation effect processing devices 25 and 29

The signals, output from the reverberation effect processing devices 25 and 29, pass through mixers 26 and 30 to enter the virtual speaker generation devices 1 and 2 of FIG. 1. The channel mixer 26 for stereo channels is expressed by the following Equation 10:

FeedXTXL=G_{FrToXTX}*L+G_{VirToXTX}*VirLs+G_{RvbToXTX}*RvbL

FeedXTXR=G_{FrToXTX}*R+G_{VirToXTX}*VirRs+G_{RvbToXTX}*RvbR (10)

where FeedXTXL, and FeedXTXR are signals that are output from the mixer 26 and are input to the virtual speaker devices 1 and 2, and G_{FrToXTX}, G_{VirToXTX} and G_{RvbToXTX} are gains.

A channel mixer 30 for multi-channel signals includes a front mixer 31 for a front signal, a surround mixer 32 for surround signals, and a center/low-frequency mixer 33 for a center signal and LFE, and the channel mixer 30 is expressed by the following Equation 11:

FeedFrXTXL=G_{FrToXTX}*L+G_{RrtoFrXTX}Ls+G_{RvbToXTX}*RvbL

FeedFrXTXR=G_{FrToXTX}*R+G_{RrtoFrXTX}*Rs+G_{RvbToXTX}*RvbR

FeedRrXTXL=G_{RrtoFrXTX}*Ls+G_{RvbToXTX}*RvbL

FeedRrXTXR=G_{RrtoFrXTX}*Rs+G_{RvbToXTX}*RvbR

OutC=C

OutLEF=LEF (11)

where FeedFrXTXL and FeedFrXTXR are output signals for the front channels of multi-channels, FeedRrXTXL and FeedRrXTXR are output signals for left and right surround channels, OutC and OutLEF are output signals for a front center channel and LFE, and G_{FrToXTX}, G_{RrtoXTX}, and G_{RvbToXTX} are gains.

Although the embodiments of the present invention have been described above, it should be noted that the present invention is not limited to the above-described embodiments, but may be modified in various manners within a range that does not depart from the spirit of the present invention, as in the case in which a device capable of performing adjustment to maximize effects depending on the relative locations of speakers or the relative locations of the speakers and a listener at the time of actual application (for example, a TV, S a forward arrangement-type home theater system, a DVD player, or a PMP player).

For example, when the mixing device 10 or 22 of the present invention is eliminated or modified, the improved performance of the present invention is sufficiently realized and used in audio products equipped with 2 or more-channel speakers (plural channel speakers), such as 5.1-channel, 3-channel, 2.1-channel, or 4-channel speakers.

Furthermore, since the present invention may be applied to speakers having short distances therebetween or low outputs, the present invention may be applied to various media devices, such as a portable media device having a 2-channel output system and a media device using low-output speakers, so that they can reproduce virtual surround channels.

Using the present invention, a virtual surround effect is achieved when a 2-channel output system outputs audio signals input in a multi-channel manner, so that the effect in which a listener feels as though he or she were listening to a multi-channel output system can be provided, and sound can be reproduced without distortion through wider-range virtual speakers, thereby enabling richer reproduction of 3D sound.

Meanwhile, existing media devices having low-output speakers or small distances between speakers provide relatively weak 3D impressions, but they can reproduce rich 3D sound using the present invention.

Furthermore, the present invention enables only stereo sound images to be enhanced without damaging the transmitting power of sound, thereby being able to achieve a rich reverberation effect.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for providing three-dimensional (3D) sound through plural channel speakers, comprising:
a stereo channel virtual speaker generation device for performing spreading of low-pitch ranges and high-pitch ranges on left and right channel signals of input stereo source sound signals, performing spreading of sound images and preservation of front sound images using the high-pitch range-spread signals, and outputting sums of left and right results of the processing;
a multi-channel virtual speaker generation device for performing spreading of low-pitch ranges and high-pitch ranges on left front channel, right front channel, left surround channel and right surround channel signals of input multi-channel source sound signals, performing spreading of sound images using the high-pitch range-spread signals, performing preservation of front sound images using front center channel and Low-Frequency Effect (LFE) channel signals, adjusting gains of results of the processing, and outputting sums of the left and right results of the processing; and
an output device for outputting the signals, output from the stereo channel virtual speaker generation device or multi channel virtual speaker generation device, to the plural channel speakers.

2. The apparatus as set forth in claim 1, wherein the plural channel speakers are stereo speakers.

3. The apparatus as set forth in claim 1, wherein the spreading of the low-pitch ranges performed by the stereo channel virtual speaker generation device is performed using the following equations:
L_process1=G_low1*LPF(L)+G_{—}bst*LPF(L)−G_lowI*LPF(R)
R_process1=G_low1*LPF(R)+G_{—}bst*LPF(R)−G_lowI*LPF(L)
where L_process1 and R_process1 are respective output values of left and right channels, G_low1, G_bst and GC_lowI are gains, and LPF is a low-pass filter.

4. The apparatus as set forth in claim 1, wherein the spreading of the low-pitch ranges performed by the multi-channel virtual speaker generation device is performed using the following equations:
L_process1=G_low1*LPF(L)+G_{—}bst*LPF(L)−G_lowI*LPF(B)
R_process1=G_low1*LPF(R)+G_{—}bst*LPF(R)−G_lowI*LPF(L)
Ls_process1=G_low1*LPF(Ls)−G_lowI*LPF(Rs)
Rs_process1=G_low1*LPF(Rs)−G_lowI*LPF(Ls)
where L_process1, R_process1, Ls_process1 and Rs_process1 are respective output values of left front, right front, left surround and right surround channels, G_low1, G_bst and G_lowI are gains, and LPF is a low-pass filter.

5. The apparatus as set forth in claim 1, wherein the spreading of the high-pitch ranges performed by the stereo channel virtual speaker generation device is performed using the following equations:
L_high=G_low2*LPF(L)+G_high*HPF(L)
R_high=G_low2*LPF(R)+G_high*HPF(R)
where L_high and R_high are respective output values of left and right channels, G_low2 and G_high are gains, and HPF is a high-pass filter.

6. The apparatus as set forth in claim 1, wherein the spreading of the high-pitch ranges performed by the multi-channel virtual speaker generation device is performed using the following equations:
L_high=G_low2*LPF(L)+G_high*HPF(L)
R_high=G_low2*LPF(R)+G_high*HPF(R)
Ls_high=G_low2*LPF(Ls)+G_high*HPF(Ls)
Rs_high=G_low2*LPF(Rs)+G_high*HPF(Rs)
where L_high, R_high, Ls_high, and Rs_high are respective output values of left front, right front, left surround and right surround channels, G_low2 and G_high are gains, and HPF is a high-pass filter.

7. The apparatus as set forth in claim 5, wherein the spreading of the sound images performed by the stereo channel virtual speaker generation device is performed using the following equations:
$$L\_process 2 = G\_plus 2 * ( L\_high + R\_high ) + ( G\_minus2 * ( G\_minus 2 * ( L\_high - M 1 ( L\_high ) ) ) - M 1 ( R\_high ) )$$
$$R\_process 2 = G\_minus 2 * ( L\_high - R\_high ) + ( G\_plus2 * ( G\_plus 2 * ( R\_high + M 1 ( R\_high ) ) ) + M 1 ( L\_high ) )$$
where L_process2 and R_process2 are respective output values of left and right channels, M1 is a crosstalk cancellation filter, and G_plus2 and G_minus2 are gains.

8. The apparatus as set forth in claim 6, wherein the spreading of sound images performed by the multi-channel virtual speaker generation device is performed using the following equations:
$$L\_process 2 = G\_plus 2 * ( L\_high + R\_high ) + ( G\_minus2 * ( G\_minus 2 * ( L\_high - M 1 ( L\_high ) ) ) - M 1 ( R\_high ) )$$
$$R\_process 2 = G\_minus 2 * ( L\_high - R\_high ) + ( G\_plus2 * ( G\_plus 2 * ( R\_high + M 1 ( R\_high ) ) ) + M 1 ( L\_high ) )$$
$$Ls\_process2 = G\_plus 2 * ( Ls\_high + Rs\_high ) + ( G\_minus 2 * ( G\_minus2 * ( Ls\_high - M 1 ( Ls\_high ) ) ) - M 1 ( Rs\_high ) )$$
$$Rs\_process 2 = G\_minus 2 * ( Ls\_high - Rs\_high ) + ( G\_plus2 * ( G\_plus 2 * ( Rs\_high + M 1 ( Rs\_high ) ) ) + M 1 ( Ls\_high ) )$$
where L_process2, R_process2, Ls_process2, and Rs_process2 are respective output values of left front, right front, left surround and right surround channels, and M1 is a crosstalk S cancellation filter, and G_plus2 and G_minus2 are gains.

9. The apparatus as set forth in claim 5, wherein the preservation of the front sound images performed by the stereo channel virtual speaker generation device is performed using the following equation:
C_process=G_plus1*(L_high+R_high)
where G_plus1 is a gain.

10. The apparatus as set forth in claim 7, wherein the outputting of the suns of the left and right results performed by the stereo channel virtual speaker generation device is performed using the following equations:
L_process=L_process1+L_process2+C_process
R_process=R_process1+R_process2+C_process

11. The apparatus as set forth in claim 8, wherein the outputting of the sums of the left and right results performed by the multi-channel virtual speaker generation device is performed using the following equations:
$$L\_process = G\_level 1 * L\_process 1 + G\_level 1 * L\_process 2 + G\_level 2 * Ls\_process1 + G\_level 2 * Ls\_process 2 + G\_level 3 * ( C + LEF )$$
$$R\_process = G\_level 1 * R\_process 1 + G\_level 1 * R\_process 2 + G\_level 2 * Rs\_process1 + G\_level 2 * Rs\_process 2 + G\_level 3 * ( C + LEF )$$
where G_level1, G_level2, and G_level3 are gains that are used for adjustment of output level and downmixing.

12. The apparatus as set forth in claim 1, further comprising:
a first stereo sound image enhancement device installed in front of the stereo channel virtual speaker generation device, and configured to enhance stereo sound images using left and right channel signals of the input stereo source sound signals and provide the sound image-enhanced stereo input signals to the stereo channel virtual speaker generation device; and
a second stereo sound image enhancement device installed in front of the multi-channel virtual speaker generation device, and configured to enhance stereo sound images using left front channel, right front channel, left surround channel and right surround channel signals of the input multi-channel source sound signals and provide the sound image-enhanced stereo input signals to the multi-channel virtual speaker generation device.

13. The apparatus as set forth in claim 12, wherein the first and second stereo sound image enhancement device, respectively comprises:
a pseudo-stereo creation device for extracting pseudo-stereo signal components from the stereo channel signals;
a reverberation effect processing device for realizing a reverberation effect using an output of the pseudo-stereo device; and
a mixer for performing mixing using outputs of the pseudo-stereo device and the reverberation effect processing device.

14. The apparatus as set forth in claim 13, wherein the pseudo-stereo generation device extracts the pseudo-stereo components by processing the input left and right channel signals using the following equations:
VirLs=G_{LmR}*(L−R)+G_{LpR}*(L+R)
VirRs=G_{LpR}*(L+R)+G_{LmR}*(L−R)
where G_{LmR} and G_{LpR} are gains that are used for adjustment of intensity of stereo components and adjustment of degree of extraction.

15. The apparatus as set forth in claim 14, wherein the reverberation effect processing device in the first stereo sound image enhancement device performs processing using the following equations:
RvbL=G_{Rvb}*((G_{VirToRvb}VirLs)+(G_{FreToRVB}*L))
RvbR=G_{Rvb}*((G_{VirToRvb}VirRs)+(G_{FreToRvb}*R))
where G_{Rvb}, G_{VirToRvb} and G_{FreToRvb} are gains that are used for adjustment of a sound field effect.

16. The apparatus as set forth in claim 14, wherein the reverberation effect processing device in the second stereo sound image enhancement device performs processing using the following equations:
RvbL=G_{Rvb}*((G_{VirToRvb}VirLs)+(G_{FreToRvb}*LS))
RvbR=G_{Rvb}*((G_{VirToRvb}VirRs)+(G_{FreToRvb}*Rs))
where G_{Rvb}, G_{VirToRvb} and G_{FreToRvb} are gains that are for adjustment of a sound field effect, and Ls and Rs are respective left and right surround channel signals of the multiple channels.

17. The apparatus as set forth in claim 15, wherein the mixer in the first stereo sound image enhancement device performs mixing using the following equations:
FeedXTXL=G_{FrToXTX}*L+G_{VirToXTX}*VirLs+G_{RvbToXTX}*RvbL
FeedXTXR=G_{FrToXTX}*R+G_{VirToXTX}*VirRs+G_{RvbToXTX}*RvbR
where G_{FrToXTX}, G_{VirToXTX} and G_{RvbToXTX} are gains.

18. The apparatus as set forth in claim 16, wherein the mixer in the second stereo sound image enhancement device comprises a front mixer for outputting front signals, a surround mixer for outputting surround signals and a center/low-frequency mixer for outputting a center signal and an LFE signal, the mixers performing mixing using the following equations:
FeedFrXTXL=G_{FrToXTX}*L+G_{RrtoFrXTX}*Ls+G_{RvbTpXTX}*RvbL
FeedFrXTXR=G_{FrToXTX}*R+G_{RrtoFrXTX}*Rs+G_{RvbToXTX}*RvbR
FeedRrXTXL=G_{RrtoFrXTX}*Ls+G_{RvbToXTX}*RvbL
FeedRrXTXR=G_{RrtoFrXTX}*Rs+G_{RvbToXTX}*RvbR
OutC=C
OutLEF=LEF
where FeedFrXTX and FeedFrXTXR are output signals for front channels of multi-channels, FeedRrXTXL and FeedRrXTXR are output signals for left and right surround channels, OutC and OutLEF are output signals for a front center channel and a LFE channel, and G_{FrToXTX}, G_{RrtoXTX}, and G_{RvbToXTX} are gains.
